(19) United States
(12) Patent Application Publication
(10) Pub. No.: US 2007/0219840 A1
(43) Pub. Date: Sep. 20, 2007

(54) SYSTEM AND METHOD FOR WEB BASED PROJECT MANAGEMENT

(75) Inventors: Randye K. Rabb, Oro Valley, AZ (US); Dwight C. Ferrick, Oro Valley, AZ (US); Mack F. Dickerson, Tucson, AZ (US); Paul J. Morgan, Tucson, AZ (US); Keith E. Ganske, Tucson, AZ (US)

Correspondence Address: SNELL & WILMER L.L.P. (Main), 400 EAST VAN BUREN, ONE ARIZONA CENTER, PHOENIX, AZ, 85004-2202, US

(73) Assignee: TIERRA RIGHT OF WAY SERVICES, LTD., Tucson, AZ (US)

(21) Appl. No.: 11/684,486

(22) Filed: Mar. 9, 2007

Related U.S. Application Data
(60) Provisional application No. 60/780,898, filed on Mar. 9, 2006.

(51) Int. Cl. G05B 19/418

(52) U.S. Cl. 705/8

(57) ABSTRACT

A system and method for web based project management which tracks, manages and assesses multiple project types associated with one or more land parcels.

### CROSS-REFERENCE TO RELATED APPLICATIONS

This application claims priority to provisional patent application having Ser. No. 60/780,898 filed Mar. 9, 2006, which is herein incorporated in its entirety.

### FIELD OF INVENTION

The present invention relates, generally, to a system and method for web based project management which tracks multiple project types associated with one or more land parcels.

### BACKGROUND OF THE INVENTION

A vast number of systems and methods for managing projects and project data are known in the art. The complexity level of projects continue to increase every day resulting in a need for more and more sophisticated methods and systems for tracking and evaluating projects and project data.

The development of land, from the planning stages to the end result, is a process that has come to require more tasks and more time to complete. Most land developers must undertake a great deal of pre-planning before even breaking ground. In addition, a number of other projects may be associated with a piece of land or land parcel which may also require a number of complex tasks where one or more tasks may be so interrelated as to require management and action items performed by a number of people to carry out the tasks.

To complicate matters even further, many land developers and land management entities are developing and managing a number of projects on a number of different land parcels or pieces of real property at the same time. Accordingly, there is a need for a method for tracking and managing multiple projects being carried out at the same time that are associated with one or more land parcels.

### SUMMARY OF THE INVENTION

The present invention provides a method for tracking multiple project types associated with one or more land parcels which includes the steps of identifying one or more projects associated with a land parcel(s), designating performance tasks to complete each project, determining milestones for at least one of the projects and the land parcel, documenting execution of the performance tasks including an individual's name and time spent executing the performance task, and generating automated reports of activities and status of the projects upon the completion of the milestones. These method steps may be implemented by providing a system that can be accessed via at least one of an intranet and internet.

The projects tracked with the method and system of the invention may include, but are not limited to, land acquisition and relocation assistance projects, archeological projects, environmental projects, planning services projects, real estate projects, asset management projects, and survey and mapping projects. Documentation of the performance tasks may be done in real time and the automated reports that are generated may be automatically forwarded to clients in real time.

The method of the invention may also include the step of generating employee time sheets based upon the documentation of performance task execution, the steps of creating client billing records and generating client invoices based on documentation of performance task execution, the step of creating one or more reports by searching at least one of a client identifier, a project identifier, a land parcel identifier, a performance task identifier, a milestone identifier, or an individual task performer identifier, the steps of creating a budget for one or more projects and land parcels and enabling one or more individuals to amend the budget, and the step of enabling one or more users to add and/or delete projects, performance tasks, and milestones.

The present invention is also directed to a project and time/cost management system that includes a web based host server including a processor for processing information, one or more input modalities for imputing information to the server, a memory coupled to the server having at least one database for storing information including land parcel information, project information, performance task information, milestone information, and performance task execution information including the individual performing the task and time to perform the task, an application program stored in the memory and accessible by the processor for directing processing of the information by the processor, and a display coupled to the processor and memory for displaying information derived from the information processed by the processor.

The system of the invention may generate automated reports upon completion of milestones and/or projects, employee time sheets and or client billing records based on performance task execution, and invoices for payment based on client billing records. The system may track real time progress of multiple land projects based on information including land parcel information, project information, performance task information, milestone information, and performance task execution information including the individual performing the task and the time to perform the task.

### DESCRIPTION OF THE DRAWINGS

The figures illustrate various embodiments of the present invention by way of example, and not by way of limitation. The embodiments of the present invention may include part or all of the features shown in one of these figures, or may include features from two or more figures. Embodiments of the present invention may also include features described in the specification, or elements of features described in the specification. Furthermore, embodiments of the present invention may include features that would be familiar to a person of ordinary skill in the art having studied this document. Thus, a more complete understanding of the present invention may be derived by referring to the detailed description and claims when considered in connection with the drawing figures where like reference numbers refer to similar elements throughout the figures, and

FIG. 1 is a block diagram of a project and time/cost management system in accordance with the present invention;

FIG. 2 is a block diagram of another exemplary embodiment of a project and time/cost management system in accordance with the present invention;

FIG. 3 is a flow chart showing one exemplary embodiment of a method for tracking multiple project types associated with one or more land parcels in accordance with the present invention; and

FIG. 4 is a chart showing a list of multiple project types that may be carried out in accordance with the method for tracking multiple project types associated with one or more land parcels of the present invention.

### DETAILED DESCRIPTION

The detailed description of exemplary embodiments herein makes reference to the accompanying drawings and pictures, which show the exemplary embodiment by way of illustration and its best mode. While these exemplary embodiments are described in sufficient detail to enable those skilled in the art to practice the invention, it should be understood that other embodiments may be realized and that logical and mechanical changes may be made without departing from the spirit and scope of the invention. Thus, the detailed description herein is presented for purposes of illustration only and not of limitation. For example, the steps recited in any of the method or process descriptions may be executed in any order and are not limited to the order presented. Furthermore, any reference to singular includes plural embodiments, and any reference to more than one component may include a singular embodiment.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

The various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include, but are not limited to, client data, product data, personal data, real estate data, land data, map data, employment data, service data, etc. As those skilled in the art will appreciate, user computer may include an operating system (e.g., Windows NT, 95/98/2000, OS2, UNIX, Linux, Solaris, MacOS, etc.) as well as various conventional support software and drivers typically associated with computers. The computer may include any suitable personal computer, network computer, workstation, minicomputer, mainframe or the like. User computer can be in a home or business environment with access to a network. In an exemplary embodiment, access is through a network or the Internet through a commercially-available web-browser software package.

As used herein, the term “network” shall include any electronic communications means which incorporates both hardware and software components of such. Communication among the parties may be accomplished through any suitable communication channels, such as, for example, a telephone network, an extranet, an intranet, Internet, point of interaction device (point of sale device, personal digital assistant (e.g., Palm Pilot®, Blackberry®), cellular phone, kiosk, etc.), online communications, satellite communications, off-line communications, wireless communications, transponder communications, local area network (LAN), wide area network (WAN), networked or linked devices, keyboard, mouse and/or any suitable communication or data input modality. Moreover, although the system is frequently described herein as being implemented with TCP/IP communications protocols, the system may also be implemented using IPX, Appletalk, IP-6, NetBIOS, OSI or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, DILIP NAIK, INTERNET STANDARDS AND PROTOCOLS (1998); JAVA 2 COMPLETE, various authors, (Sybex 1999); DEBORAH RAY AND ERIC RAY, MASTERING HTML 4.0 (1997); and LOSHIN, TCP/IP CLEARLY EXPLAINED (1997) and DAVID GOURLEY AND BRIAN TOTTY, HTTP, THE DEFINITIVE GUIDE (2002), the contents of which are hereby incorporated by reference.

The various system components may be independently, separately or collectively suitably coupled to the network via data links which includes, for example, a connection to an Internet Service Provider (ISP) over the local loop as is typically used in connection with standard modem communication, cable modem, Dish networks, ISDN, Digital Subscriber Line (DSL), or various wireless communication methods, see, e.g., GILBERT HELD, UNDERSTANDING DATA COMMUNICATIONS (1996), which is hereby incorporated by reference. It is noted that the network may be implemented as other types of networks, such as an interactive television (ITV) network. Moreover, the system contemplates the use, sale or distribution of any goods, services or information over any network having similar functionality described herein.

As used herein, “transmit” may include sending electronic data from one system component to another over a network connection. Additionally, as used herein, “data” may include encompassing information such as commands, queries, files, data for storage, and the like in digital or any other form.

The system contemplates uses in association with web services, utility computing, pervasive and individualized computing, security and identity solutions, autonomic computing, commodity computing, mobility and wireless solutions, open source, biometrics, grid computing and/or mesh computing.

Any databases discussed herein may include relational, hierarchical, graphical, or object-oriented structure and/or any other database configurations. Common database products that may be used to implement the databases include DB2 by IBM (White Plains, N.Y.), various database products available from Oracle Corporation (Redwood Shores, Calif.), Microsoft Access or Microsoft SQL Server by Microsoft Corporation (Redmond, Wash.), or any other suitable database product. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors.

More particularly, a “key field” partitions the database according to the high-level class of objects defined by the key field. For example, certain types of data may be designated as a key field in a plurality of related data tables and the data tables may then be linked on the basis of the type of data in the key field. The data corresponding to the key field in each of the linked data tables is preferably the same or of the same type. However, data tables having similar, though not identical, data in the key fields may also be linked by using AGREP, for example. In accordance with one embodiment, any suitable data storage technique may be utilized to store data without a standard format. Data sets may be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); Binary Large Object (BLOB); stored as ungrouped data elements encoded using ISO/IEC 7816-6 data elements; stored as ungrouped data elements encoded using ISO/IEC Abstract Syntax Notation (ASN.1) as in ISO/IEC 8824 and 8825; and/or other proprietary techniques that may include fractal compression methods, image compression methods, etc.

The data can be stored without regard to a common format. However, in one exemplary embodiment, the data set (e.g., BLOB) may be annotated in a standard manner when being inputted. The annotation may comprise a short header, trailer, or other appropriate indicator related to each data set that is configured to convey information useful in managing the various data sets. For example, the annotation may be called a “condition header”, “header”, “trailer”, or “status”, herein, and may comprise an indication of the status of the data set or may include an identifier correlated to a specific issuer or owner of the data. In one example, the first three bytes of each data set BLOB may be configured or configurable to indicate the status of that particular data set; e.g., LOADED, INITIALIZED, READY, BLOCKED, REMOVABLE, or DELETED.

The data set annotation may also be used for other types of status information as well as various other purposes. For example, the data set annotation may include security information establishing access levels. The access levels may, for example, be configured to permit only certain individuals, levels of employees, companies, or other entities to access data sets, or to permit access to specific data sets based on project, land parcel, performance task, or the like. Furthermore, the security information may restrict/permit only certain actions such as accessing, modifying, and/or deleting data sets. In one example, the data set annotation indicates that only the data set owner or the user are permitted to delete a data set, various identified users may be permitted to access the data set for reading, and others are altogether excluded from accessing the data set. However, other access restriction parameters may also be used allowing various entities to access a data set with various permission levels as appropriate.

One skilled in the art will also appreciate that, for security reasons, any databases, systems, devices, servers or other components of the system may consist of any combination thereof at a single location or at multiple locations, wherein each database or system includes any of various suitable security features, such as firewalls, access codes, encryption, decryption, compression, decompression, and/or the like.

The computing unit of the web client may be further equipped with an Internet browser connected to the Internet or an intranet using standard dial-up, cable, DSL or any other Internet protocol known in the art. Transactions originating at a web client may pass through a firewall in order to prevent unauthorized access from users of other networks. Further, additional firewalls may be deployed between the varying components of CMS to further enhance security.

Firewall may include any hardware and/or software suitably configured to protect CMS components and/or enterprise computing resources from users of other networks. Further, a firewall may be configured to limit or restrict access to various systems and components behind the firewall for web clients connecting through a web server. Firewall may reside in varying configurations including Stateful Inspection, Proxy based and Packet Filtering among others. Firewall may be integrated within a web server or any other CMS components or may further reside as a separate entity.

The computers discussed herein may provide a suitable website or other Internet-based graphical user interface which is accessible by users. In one embodiment, the Microsoft Internet Information Server (IIS), Microsoft Transaction Server (MTS), and Microsoft SQL Server, are used in conjunction with the Microsoft operating system, Microsoft NT web server software, a Microsoft SQL Server database system, and a Microsoft Commerce Server. Additionally, components such as Access or Microsoft SQL Server, Oracle, Sybase, Informix MySQL, Interbase, etc., may be used to provide an Active Data Object (ADO) compliant database management system.

Any of the communications, inputs, storage, databases or displays discussed herein may be facilitated through a website having web pages. The term “web page” as it is used herein is not meant to limit the type of documents and applications that might be used to interact with the user. For example, a typical website might include, in addition to standard HTML documents, various forms, Java applets, JavaScript, active server pages (ASP), common gateway interface scripts (CGI), extensible markup language (XML), dynamic HTML, cascading style sheets (CSS), helper applications, plug-ins, and the like. A server may include a web service that receives a request from a web server, the request including a URL (http://yahoo.com/stockquotes/ge) and an IP address (123.56.789.234). The web server retrieves the appropriate web pages and sends the data or applications for the web pages to the IP address. Web services are applications that are capable of interacting with other applications over a communications means, such as the internet. Web services are typically based on standards or protocols such as XML, SOAP, WSDL and UDDI. Web services methods are well known in the art, and are covered in many standard texts. See, e.g., ALEX NGHIEM, IT WEB SERVICES: A ROADMAP FOR THE ENTERPRISE (2003), hereby incorporated by reference.

Practitioners will also appreciate that there are a number of methods for displaying data within a browser-based document. Data may be represented as standard text or within a fixed list, scrollable list, drop-down list, editable text field, fixed text field, pop-up window, and the like. Likewise, there are a number of methods available for modifying data in a web page such as, for example, free text entry using a keyboard, selection of menu items, check boxes, option boxes, and the like.

The system and method may be described herein in terms of functional block components, screen shots, optional selections and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, Macromedia Cold Fusion, Microsoft Active Server Pages, Java, COBOL, assembler, PERL, Visual Basic, SQL Stored Procedures, extensible markup language (XML), with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JavaScript, VBScript or the like. For a basic introduction of cryptography and network security, see any of the following references: (1) “Applied Cryptography: Protocols, Algorithms, And Source Code In C,” by Bruce Schneier, published by John Wiley & Sons (second edition, 1995); (2) “Java Cryptography” by Jonathan Knudson, published by O'Reilly & Associates (1998); (3) “Cryptography & Network Security: Principles & Practice” by William Stallings, published by Prentice Hall; all of which are hereby incorporated by reference.

Each user may interact with the system and facilitate online information and data input, information and data retrieval, service requests, and a number of other transactions. The user may do so using a computing unit in the form of a personal computer, although other types of computing units may be used including laptops, notebooks, hand held computers, set-top boxes, cellular telephones, touch-tone telephones and the like.

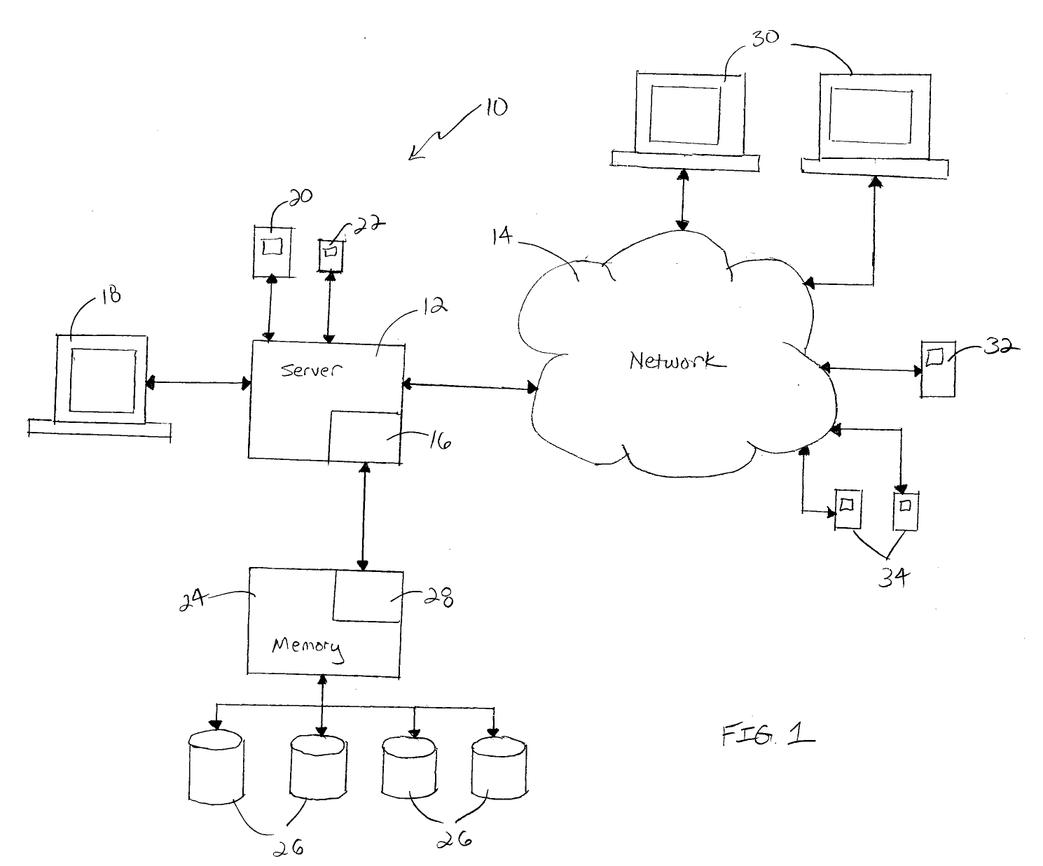

Turning now to the figures, FIG. 1 shows a block diagram of an exemplary embodiment of a project and time/cost management system 10 in accordance with the present invention. System 10 includes a web based host server 12 in communication with a network 14, such as an internet, intranet, or the like, having a processor 16 for processing information and one or more input modalities such as a computer 18, PDA or BLACKBERRY type device 20, or cell phone 22 for inputting information to the server. System 10 also includes a memory 24 coupled to server 12 wherein the memory has a plurality of databases 26 for storing information such as land parcel information, project information, performance task information, milestone information, and performance task execution information including the individual performing the task and the time taken to perform the task. In addition, system 10 includes an application program 28 stored in memory 24 and accessible by processor 16 for directing the processing of information by processor 16 and a display coupled to the processor and memory for displaying information derived from the information processed by processor 16. Such a display may comprise a number of embodiments including the screen on a computer 18, the screen on a PDA or BLACKBERRY 20, or screen on a cell phone 22. A number of other input modalities, all of which include screens, such as computers 30, a PDA or a BLACKBERRY 32, or cell phones 34 may be used to input and access data to and from the server 12 through a network 14.

Application program 28 is capable of carrying out a number of functions including 1) generating automated reports based upon the completion of at least one milestone or project identified in association with a land parcel, 2) generating employee timesheets based upon performance tasks executed to complete milestones or projects associated with the land parcel, 3) generating client billing records based upon performance tasks performed to complete a milestone and/or project associated with a land parcel, and 4) generating invoices for payment based upon client billing records that are created based upon pre-agreed fees and/or task items performed to complete a milestone and/or project associated with the land parcel. In addition, application program 28 may track real time progress of multiple land projects based on information which includes, but is not limited to, land parcel information, project information, performance task information, milestone information, and performance task execution information including the specific individuals performing tasks and the time taken to perform such tasks.

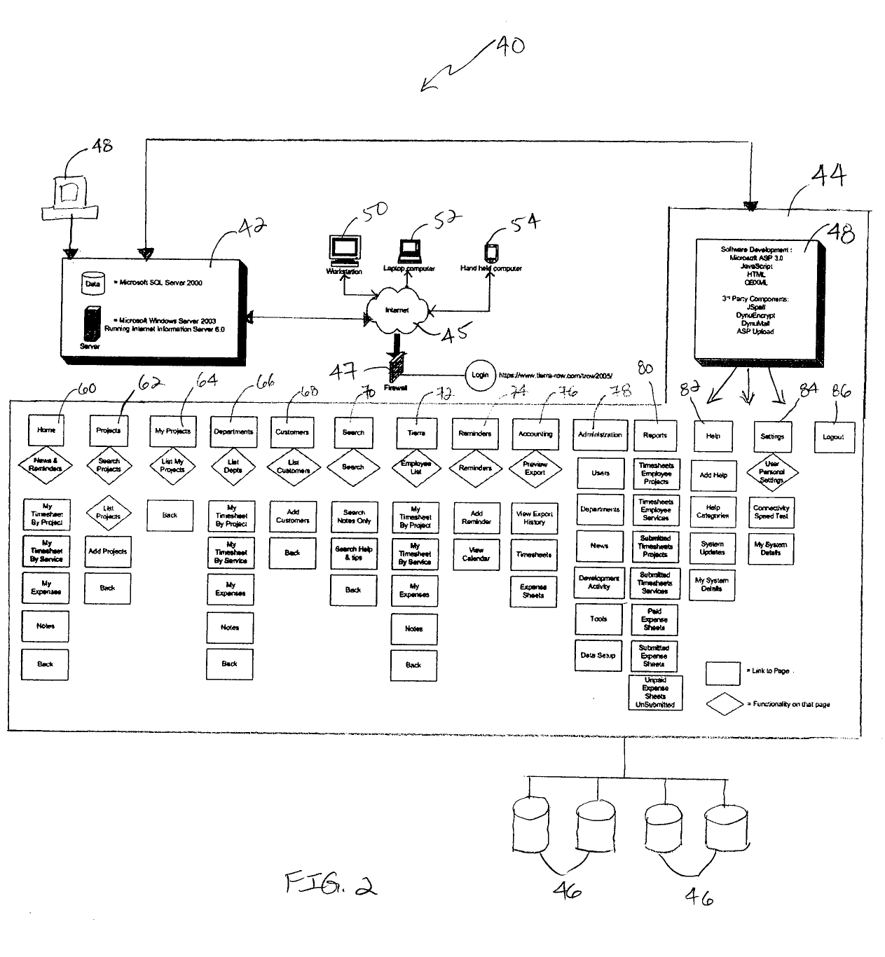

FIG. 2 shows a block diagram of another exemplary embodiment of a project and time/cost management system 40 in accordance with the present invention. System 40 includes a web based server 42 which includes a processor for processing information and one or more input modalities such as computer 48 for inputting information to the server. System 40 also includes a memory 44 having an application program 48 stored within it and accessible by the processor in server 42 for directing the processing of information. Memory 44 also includes direct or indirect communication with a plurality of databases 46 for storing information which includes, but is not limited to, land parcel information, project information, performance task information, milestone information, and performance task execution information including individuals performing specific tasks and the time taken to perform those tasks. A number of other input modalities such as computer workstation 50, laptop computer 52, and hand held computer 54, as well as other devices such as PDAs and cell phones, may be used to input and access information to and from server 42 through internet 45. System 40 may also include a firewall 47 for maintaining the security and integrity of system 40.

Application program 48 may include a number of links to various pages accessible by a user as well as functionality steps associated with the various pages accessible by a user. Application program 48 shows a number of exemplary pages accessible by a user including a home page 60, a projects page 62, an individual's or entity's project pages 64, the department's page 66, a customer's page 68, a search page 70, a computer page 72, a reminders page 74, an accounting page 76, an administration page 78, a reports page 80, a help page 82, a settings page 84, and a log out page 86. A number of functions may be performed when accessing each of these individual exemplary pages.

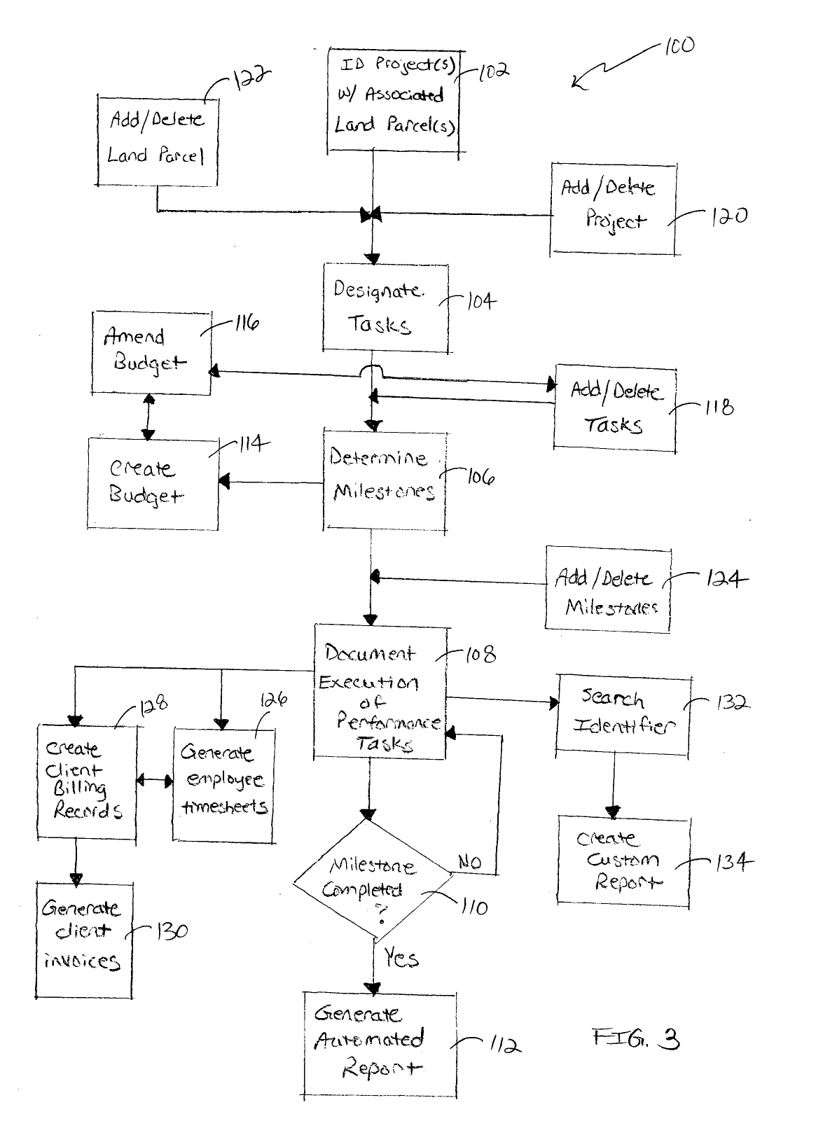

Turning now to FIG. 3, a flow chart is shown which illustrates an exemplary method 100 for tracking multiple project types associated with a land parcel in accordance with the present invention. Method 100 includes the step of identifying one or more projects associated with a land parcel or parcels 102, designating performance tasks to complete each project 104, determining milestones for at least one of the project or projects and the land parcel or parcels 106, documenting execution of the performance tasks including at least an individual's name performing the task and time spent executing the performance task 108, determining whether a milestone has been completed 110, generating an automated report 112 when a milestone has been completed, and returning to the step of documenting execution of performance task 108 when a milestone has not been completed. After the steps of designating performance task 104 and determining milestones 106 have been completed, a budget may be created 114 and that budget may be amended 116 based on a number of factors including the addition or deletion of performance tasks 118, the addition and/or deletion of a project 120, and/or the addition and/or deletion of a land parcel 122. Milestones may also be added and/or deleted in step 124 which will affect the generated automation of reports in step 112. It will also be understood by those skilled in the art that the addition and/or deletion of land parcels, projects, performance tasks, and/or milestones in steps 122, 120, 118, and 124 may be performed as part of the method regardless of whether or not the step of creating a budget 114 is included in method 100.

Method 100 may also include the steps of generating employee timesheets 126 and creating client billing records 128 after documenting execution of performance tasks 108. In addition, client billing records and/or employee timesheets may be used to generate client invoices 130. Furthermore, in addition to generating automated reports in step 112, specific identifiers may be searched in step 132 to create a custom report 134. The search of specific identifiers may include, but is not limited to, searches of client identifiers, project identifiers, land parcel identifiers, performance task identifiers, milestone identifiers, and individual task performer identifiers.

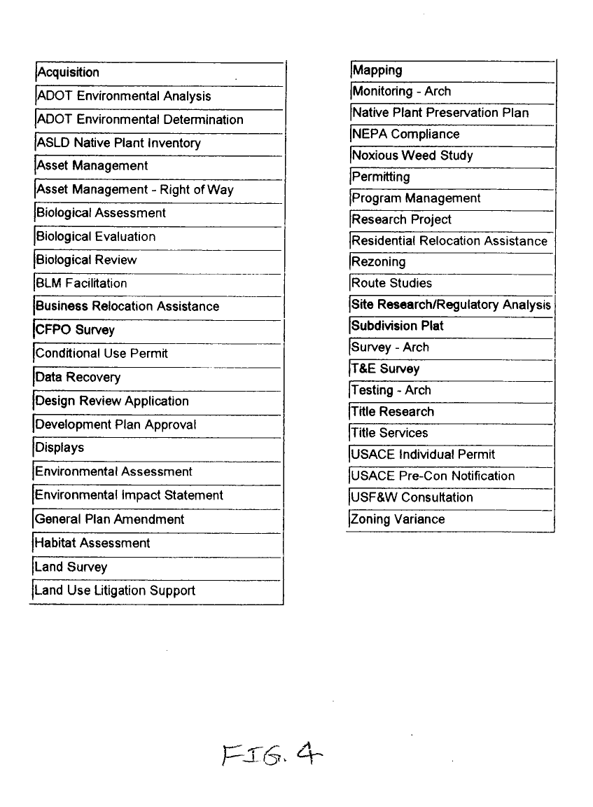

The step of identifying the project or projects with an associated land parcel or parcels 102 may include the identification of a number of projects. FIG. 4 is a table listing a number of projects that may be associated with a land parcel or parcels which can be tracked, managed, and assessed using the system and method of the present invention. The projects associated with a land parcel or parcels include, but are not limited to, acquisition, environmental analysis, environmental determination, native plant inventory, asset management, asset management with respect to right of way, biological assessment, biological evaluation, biological review, Bureau of Land Management (BLM) facilitation, business relocation assistance, various types of surveys, conditional use permit, data recovery, design review application, development plan approval, displays, environmental assessment, environmental impact statements, general plan amendment, habitat assessment, land survey, land use litigation support, mapping, archeological monitoring, native plant preservation planning, national environmental policy act compliance, noxious weed study, permitting, program management, research project, residential relocation assistance, rezoning, root studies, site research in regulatory analysis, subdivision plat, archeological surveying, archeological testing, title research, title services, individual permits, pre-verifications, consultation, and zoning variance.

Each project in system 10, 40 and method 100 can have multiple project types and projects consisting of land level items known as parcels. Each project and parcel can have notes associated with user/agent actions on a given project. The project and parcel notes may consist of details regarding department, employee title, service provided, notated documentation and the time it took to complete. As previously described, these notes are later translated into client billing records/reports for invoicing and employee timesheets for accounting. Time can also be exported and then imported into QuickBooks Enterprise accounting system.

As previously described, projects may utilize milestones that check off certain steps of project process. These milestones are customizable via each project type that is associated with a project. When a milestone is completed, reports are automatically updated for clients to review real-time. The system has complete interface and control of all the database data. This means that any portion on a database can be modified via the web application. In addition, the system utilizes multiple user levels of security which dictates available use or functionality.

System 10, 40 and method 100 may include a number of functionalities including:
Document Management System—related to parcels and/or projects. Backed up in DB;
Real-Time Timesheets—employee viewable and approval process;
News Items—for company news;—for company news;
Personal Reminder—for individual users;
Login IP and Access Tracking—for security;
Delete Auto Backup—items deleted are backed up in the database;
Application Backup—backup option to save all Trow2005 application files to DB;
Budgeting Module—allows detailed budget setup per project and parcel;
Expense Tracking—of employee, vendor and other expenses per project and parcel;
Complete Search—search projects, parcels or notes;
Milestones—for project setup to determine completed tasks; and
Reports—custom status reports and contacts sheets for each client that needs it.

A number of technologies may also be used to operate system 10, 40 and method 100. In one exemplary embodiment of system 10, 40 the system may be built using Microsoft technology where the database is a Microsoft SQL Server 2000, the web server is a Microsoft Internet Information Server 6.0 (IIS), a server scripting of A.S.P. (Active Server Pages) with VBScript, and other languages including HTML, JavaScript, and Cascading Style Sheets (CSS). In addition, one exemplary embodiment may utilize third party components such as J Spell—Web Server Spelling Dictionary, ASP Upload—Web Server file upload component, and DynuEncrypt—Dynu Systems, Inc. for cookie encryption.

As previously described above, any number of projects may be carried out in accordance with one or more land parcel or parcels with the main project types including right of way, asset management, development service, environmental, archeology, mapping, corp, survey, and hardware service. Billable titles for those carrying out performance tasks may include, but are not limited to, project manager, project supervisor, clerical, senior agent, field agent, permit specialist, staff agent, legal, CAD/GIS printing technician, coordinator, editor, IT services, survey crew, RLS, planner, biologist, environmental tech, landscape architect, database specialist, field supervisor, crew chief, crew member, monitor, laboratory specialist, laborer, field director, and clerical/word processor. In addition, global reports may include, but are not limited to, project status, contact sheets, timesheets, expense sheets, and budgets.

Billable departments may be based on type of project. Exemplary billable departments include, but are not limited to, the following department descriptions and possible associated customer reports:

Right of Way

Right of Way Department is responsible for property acquisition and relocation services. A project contains properties, which contain parcels. Some clients have many projects others have many properties both of which can be interpreted differently. A client may present you with 100 project Ids, which may mean 100 property Ids under 1 project in the system.
Custom Reports: Contact Reports, Project Status Reports, Budget Reports
   Asset Management
Asset Management Department is responsible for working with existing client base industry as well as out-of-industry clients that purchase and maintain real property and related assets to assist with the inventory, sale, lease and management of excess property.
Custom Reports: Contact Reports, Parcel Inventory Reports, Project Status Reports, Budget Reports
   Development Service
Development Services is responsible for working with Real Property Developers, Builders, Agencies, Electric, Telecom, Pipeline Companies and the general public to assist with the Determination of Entitleties, Due Diligence, Zoning Variances, Conditional Use Agreements and Permits and related activities relative to the development of property or for the installation of equipment/facilities.
Custom Reports: Contact Reports, Project Status Reports, Budget Reports
   Environmental
Environmental Department is responsible for working with Real Property Developers, Builders Public Agencies, Electric Telecom, Pipeline Companies and the general public to assist with the biologic analysis of threatened and endangered plant and animal species and habitat and prepare such impact statements, analyses, assessments, reports, etc. as may be required by law or regulation relative to the timely completion of client projects.
Custom Reports: Contact Reports, Project Status Reports, Budget Reports
   Archaeology
Archaeology Department is responsible for working with Real Property Developers, Builders, Public Agencies, Electric, Telecom, Pipeline Companies and the general public to assist with the research and inspection of property for cultural resources, recover and analyze such resources, and prepare such assessments, reports, etc. as may be required by law or regulation relative to the timely completion of client projects.
Custom Report: Contact Reports, Project Status Reports, Budget Reports
   Mapping
Mapping Department is responsible for working with all of the company departments and divisions as a support group to provide such maps, plans, plats, features and exhibits as may be required in connection with Right of Way, Archaeology and Environment, Survey, Planning and Zoning, and Asset Management projects.
Custom Reports: Contact Reports, Project Status Reports, Budget Reports
   Corp
Corporate Division includes the Executive Officers, Senior Management and Accounting Group. This division is a management and finance group overseeing the projects and activities of the company.
Custom Reports: Contact Reports, Project Status Reports, Budget Reports
   Hardware Service
This involves the renting of hardware in the field for use on projects by Tierra ROW employees or contractors.
Reports: Contact Reports, Budget Reports

The billing module of system 10, 40 and method 100 is directly related to project documentation. Services are billed according to time or as a flat project cost. However, even though some projects are built at flat project costs, employees may still document time and actions associated with flat rate projects. With the system of the present invention, accounting may have the option to export the total flat rate for billing or individual hours when a project is marked as a flat rate.

All projects used in accordance with the system and method of the present invention may have a budget set up. A budget schedule may be written for each project and each of the departments involved with the project. In addition, hourly rates may be set for each service associated with a particular project. Rates may differ from client to client and from project to project. Project managers may manipulate department budgets after master budgets have been set.

Each project may have its own list of schedules and checkpoints to go by for project completion. These checkpoints may be depicted in the status report by default. However, checkpoints may be based on dates and activities outside the normal status report. Each scheduling module may be created separate from the status reports and can be used to notify agents of upcoming tasks. Searching for projects, clients, notes, or any viable piece of searchable data is handled through the search module. For example, you could type in a street name and instantly receive all properties associated with that street. A user can also type in a project or parcel ID to instantly locate an item. All notes and documentation is searchable.

Clients may be assigned a secure login where they can access only their specified client data. This is done by isolating information in a separate folder and login area so it is not possible for clients to access the internal system. Custom data expert functions may be created with the system and method of the present invention. Finally, many levels of security may be used in accordance with the system and method of the present invention. Levels of security both pertain to internal and external needs and may include, but are not limited to, firewall level security, Secure Socket Layer, Windows Level, SQL Security and application level security.

Many modifications and other embodiments of the invention set forth herein will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only not for purposes of limitation.

1. A method for tracking multiple project types associated with a land parcel comprising:
identifying one or more projects associated with a land parcel;
designating performance tasks to complete each project;
determining milestones for at least one of the one or more projects and the land parcel;
documenting execution of the performance tasks including at least an individual's name and time spent executing the performance task; and
generating automated reports of activities and status of projects upon completion of determined milestones.

2. The method of claim 1 further comprising the step of generating employee time sheets based on the step of documenting execution of the performance tasks.

3. The method of claim 1 further comprising the step of creating client billing records based on the step of documenting execution of the performance tasks.

4. The method of claim 3 wherein the step of creating client billing records includes the step of generating client invoices for payment.

5. The method of claim 1 wherein the step of documenting execution of the performance tasks comprises the step of documenting execution of the performance tasks in real time.

6. The method of claim 1 wherein the step of generating automated reports further comprises the step of forwarding the automated reports to designated clients in real time.

7. The method of claim 1 further comprising the step of enabling one or more individuals to conduct at least one of adding one or more projects to the land parcel, deleting one or more projects from the land parcel, adding one or more performance tasks to a project, deleting one or more performance tasks from a project, adding one or more milestones to at least one of a project and the land parcel, and deleting one or more milestones from at least one of a project and the land parcel.

8. The method of claim 1 wherein the method is used to track multiple project types associated with a plurality of land parcels.

9. The method of claim 1 wherein the method steps are implemented by providing a system that can be accessed via at least one of an intranet and internet.

10. The method of claim 1 further comprising the step of creating one or more reports by searching at least one of a client identifier, a project identifier, a land parcel identifier, a performance task identifier, a milestone identifier, and an individual task performer identifier.

11. The method of claim 1 further comprising the step of creating a budget for at least one of each project and the land parcel.

12. The method of claim 11 further comprising the step of enabling one or more individuals to amend the budget.

13. The method of claim 1 wherein the step of identifying one or more projects associated with a land parcel comprises the step of identifying one or more of a land acquisition and relocation assistance project, an archeological project, an environmental project, a planning services project, a real estate project, an asset management project, and a survey and mapping project.

14. A project and time/cost management system comprising:
a web based host server including a processor for processing information;
one or more input modalities for inputting information to the server;
a memory coupled to the server having a plurality of databases for storing information including land parcel information, project information, performance task information, milestone information, and performance task execution information including individual performing task and time to perform task;
an application program stored in the memory and accessible by the processor for directing processing of the information by the processor; and
a display coupled to the processor and memory for displaying information derived from the information processed by the processor.

15. The system of claim 14 wherein the application program generates automated reports based upon the completion of at least one of milestones and projects.

16. The system of claim 14 wherein the application program generates employee time sheets based upon performance task execution data.

17. The system of claim 14 wherein the application program generates client billing records based upon performance task execution data.

18. The system of claim 17 wherein the application program generates invoices for payment based upon the client billing records.

19. The system of claim 14 wherein the application program tracks real time progress of multiple land projects based on information including land parcel information, project information, performance task information, milestone information, and performance task execution information including individual performing task and time to perform task.
